(19) United States
(12) Patent Application Publication
(10) Pub. No.: US 2020/0063224 A1
(43) Pub. Date: Feb. 27, 2020

(54) BLOCK STRUCTURE, CONTAINER AND METHOD FOR CONSTRUCTING BLOCK STRUCTURE

(71) Applicant: POSCO, Pohang-Si (KR)

(72) Inventor: Jung Il KIM, Pohang-Si (KR)

(21) Appl. No.: 16/466,700

(22) PCT Filed: Dec. 19, 2016
(86) PCT No.: PCT/KR2016/014886

§ 371 Date: Jun. 5, 2019

(30) Foreign Application Priority Data
Dec. 5, 2016 (KR) 10-2016-0164439

(51) Int. Cl. C21B 7/10; F27B 1/14; F27D 1/04; F27D 1/12; F27B 1/24; F27D 1/00; F27D 1/06

(52) U.S. Cl. CPC C21B 7/10; F27B 1/14; F27D 1/04; F27D 1/12; F27D 2001/0053; F27D 1/0006; F27D 1/004; F27D 1/06; F27B 1/24

(57) ABSTRACT

Provided is a block structure that may uniformly distribute a force applied by a charging material, a container including the block structure, and a construction method applied thereto. The block structure includes: a main body having one face extending in one direction and another direction perpendicular to one direction; and a plurality of blocks coupled to one face of the main body and being in contact with each other. Further, an engaged groove and an engaging protrusion are respectively formed on both opposed faces of each of the blocks, the opposed faces facing away each other in at least one of one direction or another direction.

### TECHNICAL FIELD

The present disclosure relates to a block structure, a container, and a method for constructing the block structure, and more particularly to, a block structure that may uniformly distributes a force applied by a charging material, a container including the block structure, and a method for constructing the block structure.

### RELATED ART

A blast furnace receives a charging material such as iron ores, cokes, and the like therein, and then melts the charging material while blowing hot blast therein to produce molten iron. The blast furnace is continuously exposed in a high temperature environment. Thus, the blast furnace is vulnerable to thermal damage. Thus, a cooling system is provided to the blast furnace. A conventional cooling system includes a stave installed inside a steel plate of the blast furnace, a cooling water pipe penetrating the steel plate of the blast furnace and extending into the stave, and the like.

The stave is made of copper to facilitate heat transfer, and the copper has a lower hardness than the charging material of the blast furnace. That is, the stave is easily worn by the charging material of the blast furnace. Therefore, a dovetail groove is defined in a front face of the stave. Further, a refractory material block having a dovetail is mounted into the dovetail groove to protect the stave.

However, the charging material of the blast furnace still repeatedly to be in direct contact with the refractory material. Thus, damage is inevitable because a shear stress is concentrated on the dovetail of the refractory material block repeatedly.

That is, in the dovetail coupling structure between the stave and the refractory material block, as the charging material and the refractory material block repeatedly contact with each other, the shear stress is repeatedly concentrated on the dovetail of the refractory material block. Consequently, the refractory material block is destroyed before a desired life thereof and is dropped out early. In this case, the cooling system of the blast furnace is severely damaged and thus loses a cooling capability. Eventually, a main body of the blast furnace is subjected to the thermal damage. This requires a replacement of the entire blast furnace or a partial replacement of the cooling system. Therefore, costs are incurred, and a production of rusty water is interrupted during the replacement, thereby lowering a productivity.

(Patent Document 1) KR₁₀-2014-0034111 A

(Patent Document 2) KR₁₀-2012-0101736 A

(Patent Document 3) KR₁₀-2012-0105532 A

(Patent Document 4) KR₁₀-2014-0097448 A

(Patent Document 5) KR₁₀-2015-0110792 A

(Patent Document 6) KR₁₀-2009-0009864 A

### SUMMARY

The present disclosure provides a block structure that may uniformly distributes a force applied by a charging material, a container including the same, and a method for constructing the block structure.

A block structure according to embodiments of the present includes: a main body having one face extending in one direction and another direction perpendicular to one direction; and a plurality of blocks coupled to one face of the main body and being in contact with each other. An engaged groove and an engaging protrusion are respectively formed on both opposed faces of each of the blocks, the opposed faces facing away each other in at least one of one direction or another direction.

The block structure may further include: a plurality of fastening members respectively mounted at a plurality of positions spaced apart from each other in at least one of one direction or another direction, wherein the plurality of fastening members pass through the plurality of blocks.

A block structure according to embodiments of the present disclosure includes: a main body having one face extending in one direction and in another direction perpendicular to one direction; a plurality of blocks respectively coupled to one face and being in contact with each other; and a plurality of fastening members respectively mounted at a plurality of positions spaced apart from each other in at least one of one direction or another direction, wherein the plurality of fastening members pass through the plurality of blocks.

An engaged groove or an engaging protrusion may be formed on one face of one block, and an engaging protrusion or an engaged groove may be formed on the other face of one block. In addition, an engaged groove of another block adjacent to one block may receive the engaging protrusion of said one block, and an engaging protrusion of said another block may be inserted into the engaging groove of said one block.

An engaged groove or an engaging protrusion may be formed on a top or bottom face of one block, and an engaging protrusion or an engaged groove may be formed on a bottom or top face of one block. In addition, an engaged groove of another block adjacent to one block may receive the engaging protrusion of said one block, and an engaging protrusion of said another block may be inserted into the engaging groove of said one block.

The engaged groove may be defined to be depressed inwardly of the block and extend in a direction perpendicular to one face of the main body. Further, the engaging protrusion may protrude outwardly of the block and extend in the direction perpendicular to one face of the main body. Further, each of the engaged groove and the engaging protrusion may have a cross-section of a regular or irregular planar shape, and each of the engaged groove and the engaging protrusion may have a rounded edge.

The fastening member may contain one of a material of the main body and a material of the block.

A container according to embodiments of the present disclosure includes: a container body having a space defined therein; and a plurality of block structures arranged on an inner face of the container body. Each block structure includes: a main body having one face extending in one direction and another direction perpendicular to one direction; and a plurality of blocks coupled to one face of the main body and being in contact with each other. The block structures includes: an engaged groove and an engaging protrusion respectively formed on both opposed faces of each of the blocks, wherein the opposed faces face away each other in at least one of one direction or another direction; or a plurality of fastening members respectively mounted at a plurality of positions spaced apart from each other in at least one of one direction or another direction, wherein the plurality of fastening members pass through the plurality of blocks.

The block structures may be respectively arranged at positions spaced apart from each other in at least one of one direction or another direction and may be in contact with each other. Further, adjacent faces of adjacent block structures may be in contact with each other and may be coupled to each other via engagement between adjacent engaged groove and engaging protrusion or via each fastening member.

An engaged groove or an engaging protrusion may be formed on one face or a top face of one block, and an engaging protrusion or an engaged groove may be formed on another face or a bottom face of one block. Further, an engaged groove of another block adjacent to one block may receive the engaging protrusion of said one block, and an engaging protrusion of said another block may be inserted into the engaging groove of said one block.

The engaged groove may be defined to be depressed inwardly of the block and extend in a direction perpendicular to one face of the main body. Further, the engaging protrusion may protrude outwardly of the block and extend in the direction perpendicular to one face of the main body. Further, each of the engaged groove and the engaging protrusion may have a cross-section of a regular or irregular planar shape, and each of the engaged groove and the engaging protrusion may have a rounded edge.

The fastening member may contain one of a material of the main body and a material of the block.

A method for constructing a block structure includes: preparing a container body having an internal space therein; disposing a main body on an inner face of the container body, the main body having one face extending in one direction and in another direction perpendicular to one direction; coupling a plurality of blocks to one face of the main body and contacting the plurality of blocks with each other; and fastening adjacent faces of adjacent blocks with each other.

The fastening of the adjacent faces of the adjacent blocks with each other may include: fastening the adjacent faces of the adjacent blocks with each other using engaged grooves and engaging protrusions respectively formed on the adjacent faces of the adjacent blocks.

The fastening of the adjacent faces of the adjacent blocks with each other may include: fastening the adjacent faces of the adjacent blocks with each other via fastening members passing through the plurality of blocks at a plurality of positions spaced in at least one of one direction or another direction.

The disposing, on the inner face of the container body, of the main body may include: arranging a plurality of main bodies on the inner face of the container body with one face of each of the main bodies facing inside the container; and contacting the plurality of main bodies with each other. Further, the coupling of the faces of the plurality of blocks facing each other with each other may include: coupling faces of one block coupled to one main body and of another block coupled to the other main body and facing the one block to each other.

The container body may include a blast furnace that may produce rusty water. Further, the main body may contain a metal material or an alloy material, and the block may contain a refractory material.

The fastening member may contain at least one of a refractory material, a metal material, or an alloy material.

According to embodiments of the present disclosure, the block structure that may uniformly distributes, on the periphery, a force applied by a charging material may be obtained. That is, the block structure has an excellent durability against the charging material. This block structure is installed on the inner face of the container such that the container may be stably used for a long time. Therefore, a treatment of the charging material using the container is smoothly performed such that the productivity may be improved.

For example, when the block structure is applied to a molten iron producing process in a steel mill, a plurality of block structures may be installed inside the blast furnace and the block structures may be used as a cooling system to produce the molten iron. During this time, the charging material of the blast furnace irregularly are being in contact with the block structure, resulting in local stress on the block structure. In this case, the block structure may distribute the stress uniformly throughout the block structure and may also distribute the stress to other block structures around. That is, the local stress caused by the charging material may be distributed throughout the block structures. Therefore, an excessive stress concentration on each refractory material block that is positioned on a front face of a stave of the block structure and is directly in contact with the charging material may be prevented. Especially, a stress concentration on a dovetail of the refractory material block may be efficiently suppressed or prevented. Therefore, a life of the refractory material block and eventually a life of the entire blast furnace facility may be extended.

### BRIEF DESCRIPTION OF THE DRAWINGS

FIG. 1 is a schematic diagram of a container according to embodiments of the present disclosure.

FIG. 2 is a schematic diagram of a block structure according to embodiments of the present disclosure.

FIG. 3 is a partial diagram of a block structure according to embodiments of the present disclosure.

FIG. 4 is a schematic diagram of a block structure and a block according to a first embodiment of the present disclosure.

FIGS. 5 to 9 are schematic diagrams of block structures and blocks according to variants of a first embodiment of the present disclosure.

FIG. 10 is a schematic diagram of a block structure and a block according to a second embodiment of the present disclosure.

FIG. 11 is a schematic diagram of a block structure and a block according to a variant of a second embodiment of the present disclosure.

FIG. 12 is a schematic diagram of a block structure and a block according to a third embodiment of the present disclosure.

FIG. 13 is a schematic diagram of a block structure and a block according to a variant of a third embodiment of the present disclosure.

FIG. 14 is a schematic diagram of a block structure according to a comparative example of the present disclosure.

### DETAILED DESCRIPTION

Hereinafter, exemplary embodiments of the present disclosure will be described in detail with reference to the accompanying drawings. However, the present disclosure is not limited to the embodiments disclosed below, but may be implemented in various forms. The embodiments of the present disclosure are provided to make the disclosure of the present disclosure complete and fully inform those skilled in the art to which the present disclosure pertains of the scope of the present disclosure. The drawings may be exaggerated to illustrate the present disclosure in detail, wherein like reference numerals refer to like elements throughout.

The present disclosure relates to a block structure that may uniformly distributes a force applied by a charging material, a container including the same, and a construction method applied thereto. Hereinafter, embodiments will be described in detail based on a molten iron producing process of a steel mill. The present disclosure may be applied to a variety of processing facilities in various industries that process various charging materials.

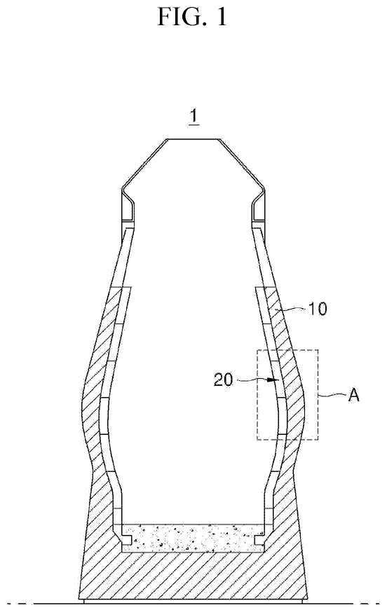

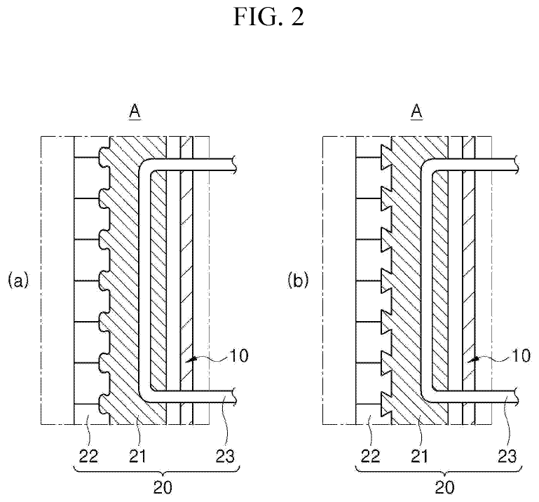

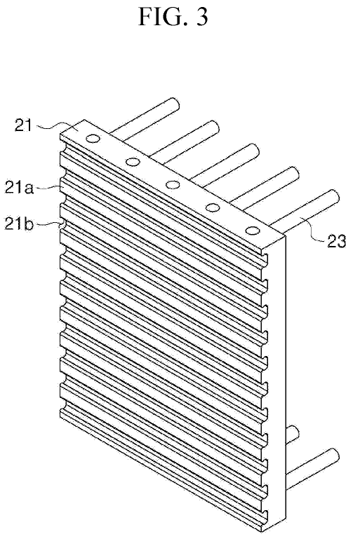

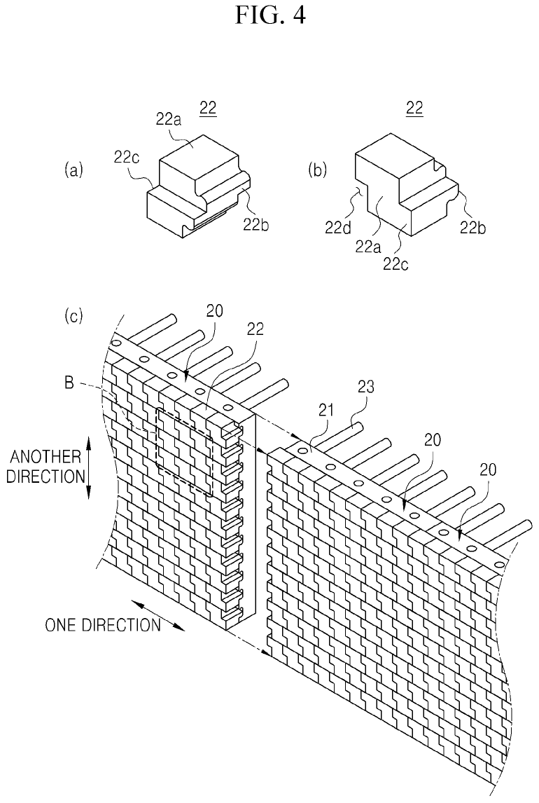

FIG. 1 is a schematic diagram of a container according to embodiments of the present disclosure. (a) and (b) in FIG. 2 are schematic diagram schematic diagrams illustrating enlarged views of a portion A in FIG. 1 to illustrate block structures according to embodiments of the present disclosure. In addition, FIG. 3 is a partial diagram of a main body of a block structure according to embodiments of the present disclosure. In addition, (a) to (c) in FIG. 4 are schematic diagrams of a block structure and blocks according to a first embodiment of the present disclosure.

Referring to FIGS. 1 to 3, a container according to embodiments of the present disclosure will be described.

A container 1 according to embodiments of the present disclosure includes a container body 10 having a space defined therein and a plurality of block structures 20 arranged on an inner face of the container body 10.

The container body 10 may form an outer wall of the container 1 and support a structure of the container 1. Further, the container body 10 may extend vertically, have the space defined therein, and have an open top. The container body 10 includes a blast furnace that may produce molten iron, for example, rusty water. More particularly, the container body 10 may include a steel plate of the blast furnace.

The block structures 20 are arranged on the inner face of the container body 10. The block structures 20 are arranged along a circumference of the inner face of the container body 10 at a plurality of positions spaced apart in a vertical direction to cover the entire inner face thereof. Thus, the block structures 20 may be in contact with each other, and coupled to each other by at least one of a block 22 or an fastening member 24 to be described below. The block structure 20 may protect the container body 10 from internal heat of the container body 10 during the production of the rusty water. The block structure 20 may be first brought into contact with a charging material such as a blast furnace charging material (iron ore, coke, etc.) charged in the container body 10 to prevent the container body 10 from being directly in contact with the charging material.

The block structure 20 includes a main body 21 having one face 21a extending in one direction (e.g., lateral direction or longitudinal direction) and another direction (e.g., vertical direction or height direction) and a plurality of blocks 22, which are coupled to one face 21a of the main body 21 and are in contact with each other.

The main body 21 is a plate-shaped member extending in one direction and another direction, and may include a stave, for example. Further, the main body 21 has a supporting structure that may support the blocks 22 on one face 21a thereof. The supporting structure may be, for example, a concave-convex structure, and more particularly, a supporting structure having a plurality of dovetail grooves 21b, for example, a dovetail supporting structure. Each of the blocks 22 has, on the other face thereof, a supporting protrusion, for example, a dovetail, which will be described later. The dovetails are fitted into the dovetail grooves 21b such that the blocks 22 are fixed to one face of the main body 21.

Further, an edge extending in one direction of each of the dovetail grooves 21b and dovetails may be chamfered or filleted. In (a) in FIG. 2, edges of the dovetail grooves 21b and dovetails are filleted and curved. In (b) in FIG. 2, edges of the dovetail grooves 21b and dovetails are angulated. In a structure in (a) in FIG. 2, a concentration of stress on each edge may be prevented. In a structure in (b) in FIG. 2, each manufacturing process and cost may be reduced.

The plurality of blocks 22 are fitted into the dovetail grooves 21b to cover one face 21a, for example, an entire front face of the main body 21 and are in contact with the charging material first to protect the main body 21 from heat and shock from the charging material. At this time, the stress is concentrated on the dovetail. Particularly, when the charging material exerts a force intensively on some of the blocks 22 without uniformly exerting the force, a strong stress is concentrated on a dovetail of each of the blocks 22 to which the force is applied.

In embodiments of the present disclosure, the plurality of blocks 22 may respectively have engaged grooves and engaging protrusions defined in or formed on faces thereof facing each other in at least one of one direction or another direction to be coupled to each other. Alternatively, fastening members, which will be described below, may penetrate in at least one of one direction or another direction, and may be mounted at a plurality of positions spaced apart in at least one of another direction or one direction.

That is, faces of the plurality of blocks 22 facing each other are in contact with and coupled to each other in a three-dimensional structure by the engaged grooves and the engaging protrusions or are firmly coupled with each other by the fastening members. This structure is very effective in transmission of loads and the like as compared with, for example, a structure in which faces facing each other are simply contacted in a two-dimensional plane form. Loads concentrated on the some of the blocks 22 may be distributed to the remaining blocks 22 with this structure. Therefore, the load may be uniformly distributed over the entire plurality of blocks 22. In one example, the loads may be distributed to blocks 22 of a neighboring block structure 20.

As such, excessive concentration of the force on each of the plurality of blocks 22 may be prevented, thereby effectively suppressing or preventing the concentration of the stress on the dovetails, which are structural weak portions of the blocks 22. That is, a life of the block 22 may be prolonged, and consequently, a life of the entire facility may be prolonged.

Further, the block structure 20 may include, for example, a refrigerant pipe as a cooling member 23. The refrigerant pipe penetrates, for example, the container body 10 and extends into the main body 21. The block structure 20 may serve as a cooling system of the blast furnace in such a manner that a refrigerant, for example, cooling water is supplied to the refrigerant pipe and circulated.

(a) in FIG. 4 is a schematic diagram illustrating a block according to a first embodiment of the present disclosure such that a rear face of the block is clearly visible. In addition, (b) in FIG. 4 is a schematic diagram illustrating a block according to a first embodiment of the present disclosure such that a front face of the block is clearly visible. In addition, (c) in FIG. 4 is a schematic diagram illustrating a block structure according to a first embodiment of the present disclosure such that one face, for example, a front face of the block is clearly visible.

Referring to FIGS. 1 to 4, a block structure according to the first embodiment of the present disclosure will be described. The block structure 20 according to the first embodiment of the present disclosure includes a main body 21 and a block 22 and may further include a cooling member 23.

The main body 21 has one face 21a extending in one direction and another direction perpendicular to one direction. The main body 21 may be, for example, a rectangular plate. A dovetail groove 21b may be defined in one face 21a of the main body 21 as a predetermined supporting structure to which the block 22 may be supported. The dovetail groove 21b may be depressed from one face 21a, for example, a front face of the main body 21 toward a rear face (also referred to as a back face) and may extend in one direction. The dovetail groove 21b may include a plurality of dovetail grooves 21b spaced apart from each other in another direction. Various supporting structures may be formed on one face of the main body 21 to support the block 22, in addition to the structure using the depressed grooves such as the dovetail grooves 21b and the concave-convex structure.

Edges of the dovetail grooves 21b may be, for example, filleted to be rounded, thereby suppressing or preventing stress from concentrating on the edge. The main body 21 may contain a metal material or an alloy material, for example, a copper material. Further, the main body 21 may include a stave.

The plurality of blocks 22 may be arranged in one direction and another direction on one face 21a of the main body 21 and respectively fitted to the dovetail grooves 21b. That is, side faces of the plurality of blocks 22 may be in contact with each other in one direction. A top face of each block 22 may be in contact with a bottom face of each vertically adjacent block 22 in another direction. That is, the plurality of blocks 22 may be in contact with each other in one direction and another direction. Further, the block 22 may contain a refractory material. For example, the block 22 may be a refractory material block. One, the other

[symbol]

The block 22 may include: a block body 22a extending in one direction or another direction to have a predetermined area and extending in a direction (e.g., a front-rear direction or a width direction) perpendicular to both one direction and another direction to have a predetermined thickness; and a supporting protrusion, for example, a dovetail 22b protruding from a rear face of the block body 22a facing one face 21a of the main body 21. The supporting protrusion protrudes from the rear face of the block body 21a toward one face 21a of the main body 21 and extends in one direction. The supporting protrusion may be formed with rounded edges and may be inserted and fitted into the dovetail groove 21b.

An engaged groove 22d and an engaging protrusion 22C may be respectively defined in and formed on faces facing each other in at least one of one direction or another direction of the plurality of blocks 22 to couple the faces. For example, the engaged groove 22d and the engaging protrusion 22C may be defined in and formed on each of the side faces of the plurality of blocks 22 facing each other in one direction.

That is, the engaged groove or the engaging protrusion may be defined in or formed on one face of one block, and the engaging protrusion or the engaged groove may be formed on or defined in the other face of the one block. Likewise, the engaged groove or the engaging protrusion may be defined in or formed on one face of each of another blocks, and the engaging protrusion or the engaged groove may be formed on or defined in the other face of each of another blocks. Further, the engaging protrusion or the engaged groove of another block facing the one block among other blocks may be inserted into or receive the engaged groove or engaging protrusion of the one block.

More specifically, for example, one engaging protrusion 22C is formed on a lower portion of one face of the one block, and, for example, one engaged groove 22d is defined in a lower portion of the other face of the one block. Further, the engaging protrusion 22C is formed on a lower portion of one face of the each of another blocks, and the engaged groove 22d is defined in a lower portion of the other face of the each of another blocks. Further, neighboring blocks may be coupled to each other in one direction in a manner engaging the engaged groove of another block facing the one block with the engaging protrusion of the one block. In this connection, the engaging protrusions or the engaged grooves of outermost blocks located on one end or both ends in one direction may be respectively coupled to engaged grooves or engaging protrusions of outermost blocks of another block structure. With this coupling structure between the blocks using the engaged grooves and engaging protrusions, the block structures that are arranged in at least one of one direction or another direction and are in contact with each other may be coupled to each other so that entire block structures may be coupled to each other. The vertical direction is another direction. In another example, the blocks may be arranged in a staggered manner from each other.

The engaged groove 22d described above may be depressed inwardly of the block 22 and extend in a direction (e.g., the front-rear direction of width direction) perpendicular to one face 21a of the main body 21. The engaging protrusion 22C may protrude outwardly of the block 22 and extend in a direction perpendicular to one face 21a of the main body 21.

In this connection, the engaged groove 22d and the engaging protrusion 22C may have cross-sections in various planar shapes of regular or irregular shapes. In the first embodiment of the present disclosure, the cross-sections may be rectangular. Although not shown in the drawings, edges of the engaged groove 22d and the engaging protrusion 22C facing each other may be rounded.

The cooling member 23 has been described sufficiently in the description of the container 1 according to the embodiments of the present disclosure, therefore, a description thereof will be omitted below.

Although the first embodiment of the present disclosure has been described with reference to FIGS. 1 to 4, the present disclosure may be implemented in various forms including following variants. For example, a structure of the block 22 of the block structure 20 according to the first embodiment of the present disclosure may be modified in various ways. Specifically, positions and the cross-sectional shapes of the engaging protrusion 22C and the engaged groove 22d may be variously modified.

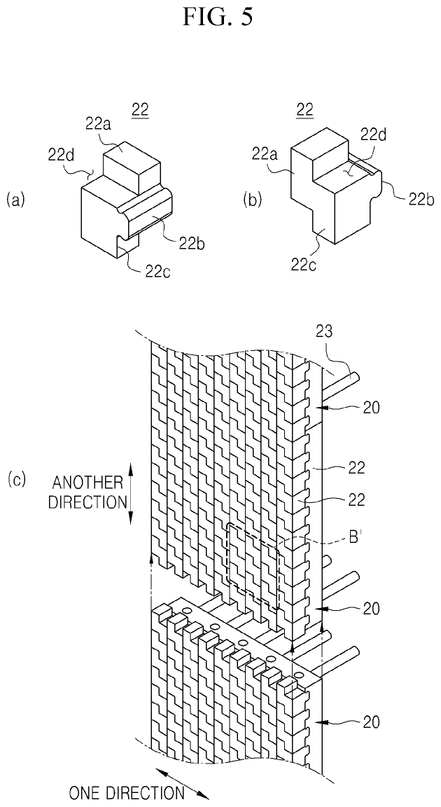

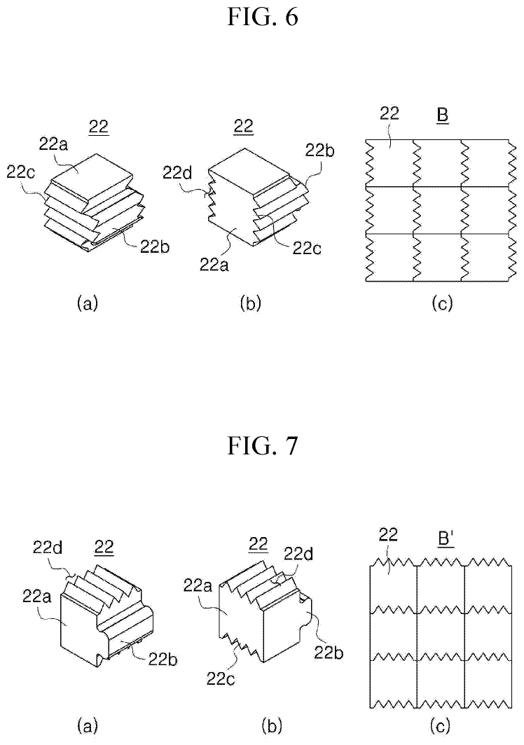

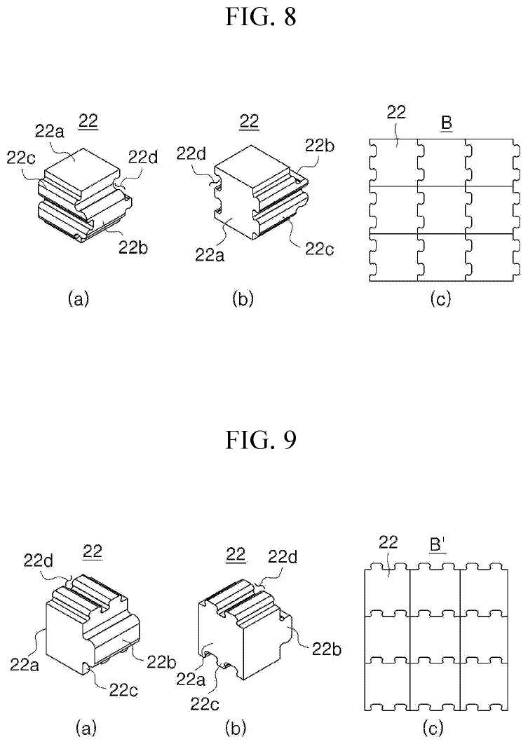

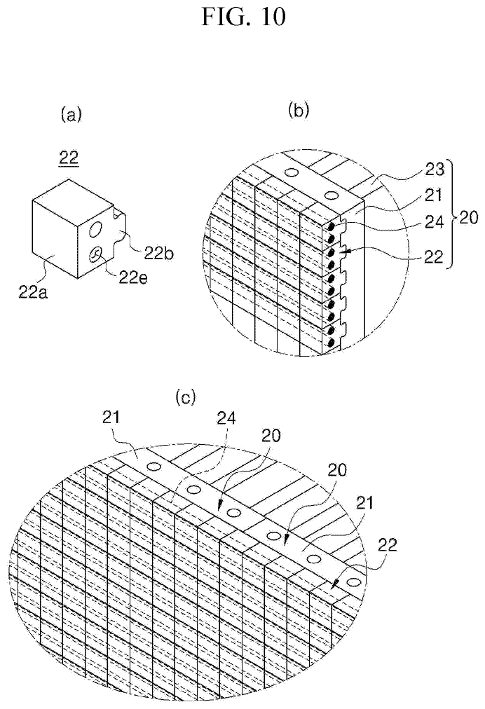

FIGS. 5 to 9 are schematic diagrams of block structures and blocks according to variants of a first embodiment of the present disclosure. FIG. 5 is a schematic diagram of a block according to a first variant. In addition, FIG. 6 is a schematic diagram of a block according to a second variant. In addition, FIG. 7 is a schematic diagram of a block according to a third variant. In addition, FIG. 8 is a schematic diagram of a block according to a fourth variant. In addition, FIG. 9 is a schematic diagram of a block according to a fifth variant. Referring to FIGS. 5 to 9, blocks according to variants of the first embodiment of the present disclosure will be described.

(a) in FIG. 5 is a schematic diagram illustrating a block according to a first variant of the present disclosure such that a rear face of the block is clearly visible. In addition, (b) in FIG. 5 is a schematic diagram illustrating a block according to a first variant of the present disclosure such that a front face of the block is clearly visible. In addition, (c) in FIG. 5 is a schematic diagram illustrating a block structure according to a first variant of the present disclosure such that one face, for example, a front face of the block is clearly visible.

Referring to (a) to (c) in FIG. 5, a structure of a block 22 according to the first variant of the present disclosure will be described.

An engaged groove 22d and an engaging protrusion 22C, as coupling structures, are respectively defined in and formed on faces of the blocks 22 facing each other in at least one of one direction or another direction. In the first variant of the plurality of blocks 22, the engaged groove 22d and the engaging protrusion 22C may be defined in and formed on each of top and bottom faces of the plurality of blocks 22 facing each other in another direction. Thus, top faces and bottom faces facing each other in another direction and being in contact with each other may be coupled to each other.

That is, for example, one engaged groove or engaging protrusion is defined in or formed on a top face or a bottom face of one block. Further, one engaging protrusion or engaged groove is formed on or defined in the bottom face or the top face of the one block. Similarly, the engaged groove or engaging protrusion is defined in or formed on a top face or a bottom face of each of other blocks and the engaging protrusion or engaged groove is formed on or defined in the bottom face or the top face of each of another blocks. Further, the engaging protrusion or the engaged groove of another block facing the one block in another direction is inserted into or receives the engaged groove or the engaging protrusion of the one block.

Referring to the drawing, the engaged groove 22d is defined in the top face of the one block, and the engaging protrusion 22C is formed on the bottom face thereof. Further, the engaged groove 22d is defined in the top face of each of another blocks, and the engaging protrusion 22C is formed on each of the bottom face thereof. Further, neighboring blocks may be coupled to each other in another direction in a manner engaging the engaged groove of another block facing the one block with the engaging protrusion of the one block. In this connection, in a case of uppermost blocks and lowermost blocks located on one end or both ends in another direction, the engaging protrusions or the engaged grooves thereof may be respectively coupled to engaged grooves or engaging protrusions of uppermost blocks and lowermost blocks of another block structure. With this coupling structure between the blocks using the engaged grooves and engaging protrusions, the block structures that are arranged in at least one of one direction or another direction and are in contact with each other may be coupled to each other so that entire block structures may be coupled.

The engaged groove 22d is defined in the top face of the block 22 to be depressed inwardly of the block 22 and extends in a direction perpendicular to one face of the main body 21. The engaging protrusion 22C protrudes outwardly of the bottom face of the block 22 and extends in a direction perpendicular to one face 21a of the main body 21. In this connection, the engaged groove 22d and the engaging protrusion 22C may have cross-sections in one direction and another direction in various planar shapes of regular or irregular shapes. In the first variant of the present disclosure, the cross-sectional shapes may be rectangular. Although not shown in the drawing, edges of the engaged groove 22d and the engaging protrusion 22C facing each other may be rounded.

(a) in FIG. 6 is a schematic diagram illustrating a block according to a second variant of the present disclosure such that a rear face of the block is clearly visible. In addition, (b) in FIG. 6 is a schematic diagram illustrating a block according to a second variant of the present disclosure such that a front face of the block is clearly visible. In addition, (c) in FIG. 6 is a schematic diagram illustrating one face of a block structure according to a second variant of the present disclosure, which corresponds to a portion B in (c) in FIG. 4.

Referring to (a) to (c) in FIG. 6, a structure of a block 22 according to the second variant of the present disclosure will be described.

An engaged groove 22d and an engaging protrusion 22C, as coupling structures, are respectively defined in and formed on faces of the blocks 22 facing each other in at least one of one direction or another direction. In the second variant, the engaged groove 22d and the engaging protrusion 22C may be defined in and formed on each of faces of the plurality of blocks 22 facing each other in one direction. Thus, the faces facing each other in one direction and being in contact with each other may be coupled to each other. Referring to the drawing, the engaging protrusion 22C on one face of one block includes, for example, a plurality of engaging protrusions and the engaged groove 22d in the other face of the one block includes, for example, a plurality of engaged grooves.

An engaging protrusion 22C formed on one face of each of other blocks includes a plurality of engaging protrusions, and an engaged groove 22d defined in the other face of each of another blocks includes a plurality of engaged grooves. Further, neighboring blocks may be coupled to each other in one direction in a manner engaging the engaged groove of another block facing the one block with the engaging protrusion of the one block. In this connection, in case of outermost blocks located on one end or both ends in one direction, engaging protrusions or engaged grooves thereof may be respectively coupled to engaged grooves or engaging protrusions of outermost blocks of another block structure. Further, the blocks arranged in a vertical direction may be arranged in another direction, but may be staggered from each other.

Further, the engaged groove 22d is defined in the other face of the block 22 to be depressed inwardly of the block 22 and extends in a front-rear direction. The engaging protrusion 22C protrudes outwardly of one face of the block 22 and extends in the front-rear direction. In this connection, the engaged groove 22d and the engaging protrusion 22C may have cross-sections in one direction and another direction in various planar shapes of regular or irregular shapes. In the second variant of the present disclosure, the cross-sectional shapes may be triangular. Although not shown in the drawing, edges of the engaged groove 22d and the engaging protrusion 22C facing each other may be rounded.

(a) in FIG. 7 is a schematic diagram illustrating a block according to a third variant of the present disclosure such that a rear face of the block is clearly visible. In addition, (b) in FIG. 7 is a schematic diagram illustrating a block according to a third variant of the present disclosure such that a front face of the block is clearly visible. In addition, (c) in FIG. 7 is a schematic diagram illustrating one face of a block structure according to a third variant of the present disclosure, which corresponds to a portion B′ in (c) in FIG. 5.

Referring to (a) to (c) in FIG. 7, a structure of a block 22 according to the third variant of the present disclosure will be described. Since the third variant of the present disclosure is similar to the first variant described above, redundant explanations will be omitted and differences will be mainly described.

Referring to the drawing, an engaged groove 22d is defined in a top face of the block 22 to be depressed inwardly of the block 22 and extends in a front-rear direction. In addition, an engaging protrusion 22C protrudes outwardly of a bottom face of the block 22 and extends in the front-rear direction. In this connection, the engaged groove 22d may include a plurality of engaged grooves, and the engaging protrusion 22C may include a plurality of engaging protrusions. Further, the engaged groove 22d and the engaging protrusion 22C may have cross-sections in one direction and another direction in various planar shapes of regular or irregular shapes. In the third variant of the present disclosure, the cross-sectional shapes may be triangular. Although not shown in the drawing, edges of the engaged groove 22d and the engaging protrusion 22C facing each other may be rounded.

(a) in FIG. 8 is a schematic diagram illustrating a block according to a fourth variant of the present disclosure such that a rear face of the block is clearly visible. In addition, (b) in FIG. 8 is a schematic diagram illustrating a block according to a fourth variant of the present disclosure such that a front face of the block is clearly visible. In addition, (c) in FIG. 8 is a schematic diagram illustrating one face of a block structure according to a fourth variant of the present disclosure, which corresponds to the portion B in (c) in FIG. 4.

Referring to (a) to (c) in FIG. 8, a structure of a block 22 according to a fourth variant of the present disclosure will be described. Since the fourth variant of the present disclosure is similar to the second variant described above, redundant explanations will be omitted, and differences will be mainly described.

Referring to the drawing, an engaged groove 22d is defined in the other face of the block 22 to be depressed inwardly of the block 22 and extends in a front-rear direction. In addition, an engaging protrusion 22C protrudes outwardly of one face of the block 22 and extends in the front-rear direction. In this connection, the engaged groove 22d may include a plurality of engaged grooves, and the engaging protrusion 22C may include a plurality of engaging protrusions. Further, the engaged groove 22d and the engaging protrusion 22C may have cross-sections in one direction and another direction in various planar shapes of regular or irregular shapes. In the fourth variant of the present disclosure, the cross-sectional shapes may be rectangular, and more specifically, cross-sectional shapes of edges may be rounded-dovetail shapes.

(a) in FIG. 9 is a schematic diagram illustrating a block according to a fifth variant of the present disclosure such that a rear face of the block is clearly visible. In addition, (b) in FIG. 9 is a schematic diagram illustrating a block according to a fifth variant of the present disclosure such that a front face of the block is clearly visible. In addition, (c) in FIG. 9 is a schematic diagram illustrating one face of a block structure according to a fifth variant of the present disclosure, which corresponds to the portion B′ in (c) in FIG. 4.

Referring to (a) to (c) in FIG. 9, a structure of a block 22 according to a fifth variant of the present disclosure will be described. Since the fifth variant of the present disclosure is similar to the first variant described above, differences will be mainly described. Referring to the drawing, an engaged groove 22d is defined in a top face of the block 22 to be depressed inwardly of the block 22 and extends in a front-rear direction. In addition, an engaging protrusion 22C protrudes outwardly of a bottom face of the block 22 and extends in the front-rear direction. In this connection, the engaged groove 22d may include a plurality of engaged grooves, and the engaging protrusion 22C may include a plurality of engaging protrusions. Further, the engaged groove 22d and the engaging protrusion 22C may have cross-sections in one direction and another direction in various planar shapes of regular or irregular shapes. In the fifth variant of the present disclosure, the cross-sectional shapes may be rectangular, and more specifically, cross-sectional shapes of edges may be rounded-dovetail shapes.

In addition to the above variants, various variants may be adopted. For example, an engaged groove or engaging protrusion may be defined in or formed on each of top, bottom, one, and the other faces of the block 22. In addition, cross-sectional shapes of the engaged groove and the engaging protrusion may be various other than the above-described shapes.

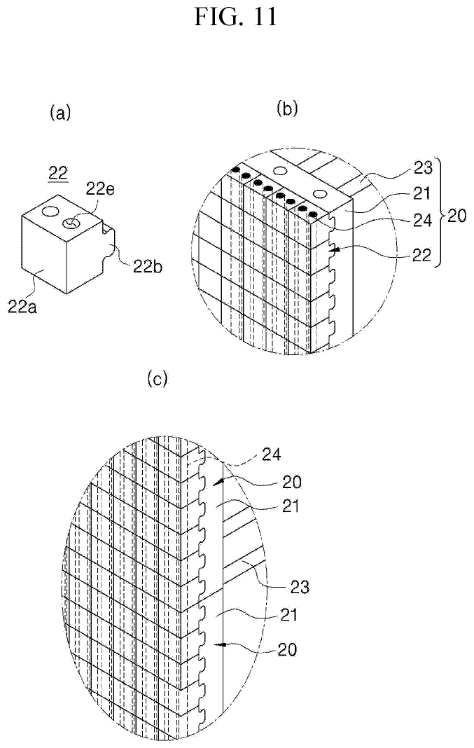

FIG. 10 is a schematic diagram of a block structure and a block according to a second embodiment of the present disclosure. In addition, FIG. 11 is a schematic diagram of a block structure and a block according to a variant of a second embodiment of the present disclosure. (a) in FIG. 10 is a schematic diagram of a block according to a second embodiment of the present disclosure, and (b) and (c) in FIG. 10 are schematic diagrams of a block structure according to a second embodiment of the present disclosure. Further, (a) in FIG. 11 is a schematic diagram of a block according to a variant of a second embodiment of the present disclosure, and (b) and (c) in FIG. 10 are schematic diagrams of a block structure according to a second variant of a second embodiment of the present disclosure.

Referring to FIGS. 10 to 11, block structures respectively according to the second embodiment and the variant thereof of the present disclosure will be described. In this connection, features of the second embodiment, which are distinguished from the first embodiment of the present disclosure, will be mainly described. The block structure according to the second embodiment of the present disclosure includes a main body 21, blocks 22 and an fastening member 24, and may further include a cooling member 23.

The main body 21 may have one face extending in one direction and in another direction perpendicular to one direction. The blocks 22 are respectively coupled to one face of the main body 21 and are in contact with each other. The block 22 may include a block body 21a, a dovetail 22b, and an engaging hole 22e.

The engaging hole 22e may include at least one engaging holes passing through the block body 21a in one direction or in another direction. For example, in the second embodiment, the engaging hole 22e may include a plurality of, for example, two engaging holes passing through the block body 21a in one direction. Further, in the variant of the second embodiment, the engaging hole 22e may include a plurality of, for example, two engaging holes passing through the block body 21a in another direction. A cross-section of the engaging hole 22e may have various shapes including circular, polygonal, irregular shapes, and the like. Fastening members 24 may be respectively inserted into the engaging holes 22e.

Each of the fastening member 24 extends in one direction or another direction. Further, a cross-section of the fastening member 24 may have various shapes including circular, polygonal, irregular shapes, and the like corresponding to the shape of the engaging hole 22e. The fastening members 24 are mounted at a plurality of positions spaced apart in at least one of one direction or another direction and pass through the plurality of blocks 22 in at least one of another direction or one direction. In the second embodiment, the fastening members 24 are mounted into the blocks 22 in one direction. On the other hand, in the variant of the second embodiment, the fastening members 24 are mounted into the blocks 22 in another direction.

In one example, in another variant of the second embodiment, the fastening members 24 may be arranged and mounted in a lattice form to pass through the plurality of blocks 22 in both one direction and another direction. In this case, the engaging holes 22e may be respectively defined to pass through the blocks 22 in both one direction and another direction. In the second embodiment and the variants thereof of the present disclosure, the plurality of blocks 22 may be coupled to each other in at least one of one direction or another direction by the fastening members 24. In this case, it is advantageous to transmit and distribute the load as compared with a structure in which mutually facing faces of the respective blocks are in contact with each other in a simple two-dimensional planar shape. With this coupling structure between the blocks using the fastening members, block structures that are arranged in at least one of one direction or another direction and are in contact with each other may be coupled to each other so that entire block structures may be coupled. Further, the fastening members 24 may include one of a material of the main body 21 and a material of the block 22. For example, the fastening members 24 may include, for example, a refractory material, and more particularly, the same material as the blocks 22.

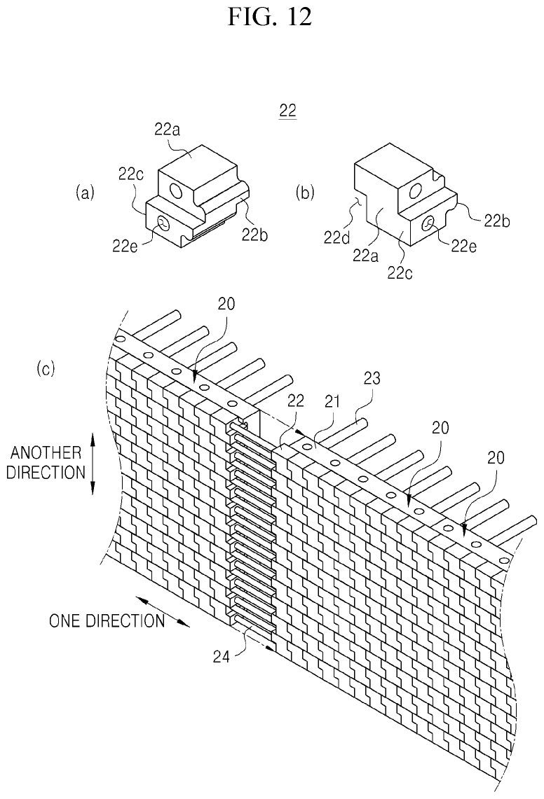

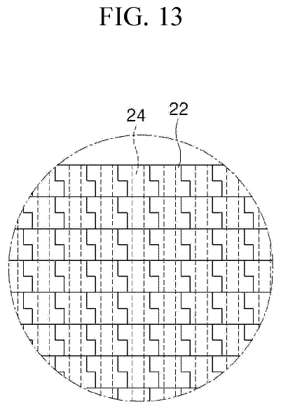

FIG. 12 is a schematic diagram of a block structure and a block according to a third embodiment of the present disclosure. (a) in FIG. 12 is a schematic diagram illustrating a block according to a third embodiment of the present disclosure such that a rear face of the block is clearly visible. (b) in FIG. 12 is a schematic diagram illustrating a block according to a third embodiment of the present disclosure such that a front face of the block is clearly visible. (c) in FIG. 12 is a schematic diagram illustrating one face of a block structure according to a third embodiment of the present disclosure. FIG. 13 is a schematic diagram of a block structure and a block according to a variant of a third embodiment of the present disclosure.

Referring to FIGS. 12 to 13, a block structure according to a third embodiment of the present disclosure will be described. The block structure according to the third embodiment of the present disclosure includes: a main body 21 having one face extending in one direction and in another direction perpendicular to one direction; a plurality of blocks 22 respectively coupled to one face and being in contact with each other; and fastening members 24 passing through the plurality of blocks 22 at a plurality of positions spaced in at least one of one direction or another direction. In this connection, an engaged groove 22d and engaging protrusion 22C may be respectively defined in or formed on faces of the plurality of blocks 22 facing each other in at least one of one direction or another direction. The block structure further includes a cooling member 23 inside the main body 21. That is, the block structure according to the third embodiment of the present disclosure is a structure in which the structures of the first and second embodiment structures are combined. Thus, the block structure of the third embodiment may distribute loads locally applied to each of the blocks 22 more smoothly to all of the blocks, and to another neighboring block structure. In this connection, in the variant of the third embodiment, an engaging direction by the engaged grooves and the engaging protrusions may intersect an engaging direction by the fastening member. This is shown in FIG. 13.

As described above, the embodiments of the present disclosure, the plurality of blocks may be coupled to each other in various ways to share the stress or load applied on the one block with other blocks or with another block structure via the coupling between the blocks. Thus, the stress or load distribution may be achieved to prevent premature failure of the block due to the excessive stress.

Further, the block is made of a refractory material having various components thereof usable in the blast furnace including SiC, SiC+Si₃N₄, graphite, and Al₂O₃ components, and combinations thereof. In the embodiments of the present disclosure, since the blocks are structurally or mechanically interconnected, a durability against the charging material may be significantly increased regardless of the refractory material component of the block. In addition, since the blocks are structurally or mechanically connected to each other regardless of the coupling form of the main body and the block, the durability against the charging material may be remarkably increased.

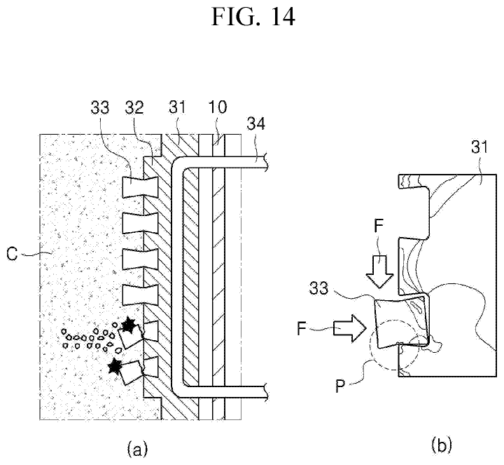

(a) in FIG. 14 is a schematic diagram illustrating a destruction mechanism of a block structure according to a comparative example of the present disclosure. In addition, (b) in FIG. 14 is a schematic diagram illustrating a stress analysis result of the block structure. Referring to FIG. 14, in the block structure according to the comparative example of the present disclosure, refractory material bricks 33 are respectively fitted into concave-convex portions 32 of a stave 31. While cooling a steel plate of a container body 10, for example, a blast furnace, with a cooling water line 34, as shown in (b) in FIG. 14, a distribution of shear stress (indicated by contour lines) by a force F applied by a charging material C in the blast furnace is densely concentrated in each confining portion between the concave-convex portion 32 and the refractory material brick 33. Therefore, the confining portion P, which is a weak point of the refractory material brick 33, is broken.

Further, even though a size of protrusions of the refractory material bricks 33 located in the charging material C is enlarged and the refractory material bricks 33 are brought into contact with each other, since each of the refractory material bricks 33 should withstand the shear stress independently, the confining portion thereof may also be easily broken. On the other hand, in the embodiments of the present disclosure, since the blocks are coupled to each other, the stress or load is distributed, so that the weak portion of each of the blocks is not broken for a long time in comparison with the above-mentioned comparative example.

Hereinafter, referring to FIGS. 1 to 13, a method for constructing the block structure according to the embodiments of the present disclosure will be described.

The method for constructing the block structure according to the embodiment of the present disclosure includes: preparing the container body having an internal space therein; disposing, on the inner face of the container body, the main body having one face extending in one direction and in another direction perpendicular to one direction; coupling the plurality of blocks to one face of the main body and contacting the plurality of blocks with each other; and coupling the faces of the plurality of blocks facing each other with each other. In this connection, the container body may include the blast furnace that may produce the rusty water. Further, the main body may contain the metal material or the alloy material, and the block may contain the refractory material.

First, the container body having the internal space therein is prepared. In this connection, the container body may be the steel plate of the container 1, for example, the blast furnace. Thereafter, the main body 21 having one face extending in one direction and in another direction perpendicular to one direction is disposed on the inner face of the container body 10. In this connection, a plurality of main bodies 21 are arranged on the inner face of the container body 10 such that one face of each of the main bodies 21 faces an inner face of the container body 10, and, thus, the plurality of main bodies 21 are brought into contact with each other. With this process, the main bodies 21 may be arranged along the inner circumference of the container body 10 at a plurality of positions spaced apart in the vertical direction to cover the entire inner face of the container body 10, and may be in contact with each other.

Thereafter, the plurality of blocks 22 are coupled to one face of the main body 21, and are brought into contact with each other. With this process, the faces of the plurality of blocks 22 facing each other are coupled to each other. The plurality of blocks 22 may be coupled with each other in at least one of one direction or another direction using, for example, the engaged grooves 22d and the engaging protrusions 22C respectively defined in and formed on the faces of the plurality of blocks 22 facing each other. Alternatively, the plurality of blocks 22 may be coupled to each other by the fastening members 24 passing through the plurality of blocks 22 at the plurality of positions spaced apart in at least one of one direction or another direction. Further, the fastening members may contain at least one of the refractory material, metal material, or the alloy material. For example, the fastening members may contain the refractory material.

There are various ways of coupling the faces of the plurality of blocks 22 that are in contact with each other. In addition to the above-described method, the plurality of blocks 22 may be coupled to each other in various manners in at least one of one direction and another direction using the engaged grooves 22d, the engaging protrusions 22C, and the fastening members 24.

Further, the faces of the plurality of blocks 21 in contact with each other may be coupled to each other such that faces of one block coupled to one main body and another block coupled to the other main body and facing the one block may be coupled to each other. That is, the plurality of block structures may be coupled to each other using the engaged grooves 22d, the engaging protrusions 22C, and the fastening members 24.

The exemplary embodiments of the present disclosure are provided to explain the spirit and scope of the present disclosure, but not to limit them. It should be noted that the configurations and methods proposed in the embodiments of the present disclosure may be combined with each other or may be replaced with each other to be modified in various forms. Thus, variants thereof may be viewed to belong to a category of the present disclosure. As a result, the present disclosure will be implemented in various forms within the scope of the claims and technical ideas within the scope equivalent to the claims. It will be understood by those skilled in the art to which the present disclosure pertains that various embodiments may be made without departing from the spirit and scope of the present disclosure.

1. A block structure comprising:
a main body having one face extending in one direction and another direction perpendicular to one direction; and
a plurality of blocks coupled to one face of the main body and being in contact with each other,
wherein an engaged groove and an engaging protrusion are respectively formed on both opposed faces of each of the blocks, the opposed faces facing away each other in at least one of one direction or another direction.

2. The block structure of claim 1, further comprising: a plurality of fastening members respectively mounted at a plurality of positions spaced apart from each other in at least one of one direction or another direction, wherein the plurality of fastening members pass through the plurality of blocks.

3. A block structure comprising:
a main body having one face extending in one direction and in another direction perpendicular to one direction;
a plurality of blocks respectively coupled to one face and being in contact with each other; and
a plurality of fastening members respectively mounted at a plurality of positions spaced apart from each other in at least one of one direction or another direction, wherein the plurality of fastening members pass through the plurality of blocks.

4. The block structure of claim 1, wherein an engaged groove or an engaging protrusion is formed on one face of one block, and an engaging protrusion or an engaged groove is formed on the other face of one block, and
wherein an engaged groove of another block adjacent to one block receives the engaging protrusion of said one block, and an engaging protrusion of said another block is inserted into the engaging groove of said one block.

5. The block structure of claim 1, wherein an engaged groove or an engaging protrusion is formed on a top or bottom face of one block, and an engaging protrusion or an engaged groove is formed on a bottom or top face of one block, and
wherein an engaged groove of another block adjacent to one block receives the engaging protrusion of said one block, and an engaging protrusion of said another block is inserted into the engaging groove of said one block.

6. The block structure of claim 1, wherein the engaged groove is defined to be depressed inwardly of the block and extends in a direction perpendicular to one face of the main body,
wherein the engaging protrusion protrudes outwardly of the block and extends in the direction perpendicular to one face of the main body, and
wherein each of the engaged groove and the engaging protrusion has a cross-section of a regular or irregular planar shape, and each of the engaged groove and the engaging protrusion has a rounded edge.

7. The block structure of claim 3, wherein the fastening member contains one of a material of the main body and a material of the block.

8. A container comprising:
a container body having a space defined therein; and
a plurality of block structures arranged on an inner face of the container body,
wherein each block structure includes:
a main body having one face extending in one direction and another direction perpendicular to one direction; and
a plurality of blocks coupled to one face of the main body and being in contact with each other,
wherein each of the block structures includes:
an engaged groove and an engaging protrusion respectively formed on both opposed faces of each of the blocks, wherein the opposed faces face away each other in at least one of one direction or another direction; or
a plurality of fastening members respectively mounted at a plurality of positions spaced apart from each other in at least one of one direction or another direction, wherein the plurality of fastening members pass through the plurality of blocks.

9. The container of claim 8, wherein the block structures are respectively arranged at positions spaced apart from each other in at least one of one direction or another direction and are in contact with each other, and
wherein adjacent faces of adjacent block structures are in contact with each other and are coupled to each other via engagement between adjacent engaged groove and engaging protrusion or via each fastening member.

10. The container of claim 8, wherein an engaged groove or an engaging protrusion is formed on one face or a top face of one block, and an engaging protrusion or an engaged groove is formed on another face or a bottom face of one block, and
wherein an engaged groove of another block adjacent to one block receives the engaging protrusion of said one block, and an engaging protrusion of said another block is inserted into the engaging groove of said one block.

11. The container of claim 8, wherein the engaged groove is defined to be depressed inwardly of the block and extends in a direction perpendicular to one face of the main body,
wherein the engaging protrusion protrudes outwardly of the block and extends in the direction perpendicular to one face of the main body, and
wherein each of the engaged groove and the engaging protrusion has a cross-section of a regular or irregular planar shape, and each of the engaged groove and the engaging protrusion has a rounded edge.

12. The container of claim 8, wherein the fastening member contains one of a material of the main body and a material of the block.

13. A method for constructing a block structure, the method comprising:
preparing a container body having an internal space therein;
disposing a main body on an inner face of the container body, the main body having one face extending in one direction and in another direction perpendicular to one direction;
coupling a plurality of blocks to one face of the main body and contacting the plurality of blocks with each other; and
fastening adjacent faces of adjacent blocks with each other.

14. The method of claim 13, wherein the fastening of the adjacent faces of the adjacent blocks with each other includes:
fastening the adjacent faces of the adjacent blocks with each other using engaged grooves and engaging protrusions respectively formed on the adjacent faces of the adjacent blocks.

15. The method of claim 13, wherein the fastening of the adjacent faces of the adjacent blocks with each other includes:
fastening the adjacent faces of the adjacent blocks with each other via fastening members passing through the plurality of blocks at a plurality of positions spaced in at least one of one direction or another direction.

16. The method of claim 14, wherein the disposing, on the inner face of the container body, of the main body includes:
arranging a plurality of main bodies on the inner face of the container body with one face of each of the main bodies facing inside the container; and
contacting the plurality of main bodies with each other, and
wherein the coupling of the faces of the plurality of blocks facing each other with each other includes:
coupling faces of one block coupled to one main body and of another block coupled to the other main body and facing the one block to each other.

17. The method of claim 13, wherein the container body includes a blast furnace that may produce rusty water,
wherein the main body contains a metal material or an alloy material, and
wherein the block contains a refractory material.

18. The method of claim 15, wherein the fastening member contains at least one of a refractory material, a metal material, or an alloy material.
